(19) United States
(12) Patent Application Publication
(10) Pub. No.: US 2007/0144509 A1
(43) Pub. Date: Jun. 28, 2007

(54) Tile cutter

(76) Inventor: Jiangnan Li, Nanjing (CN)

Correspondence Address: MCDERMOTT, WILL & EMERY LLP, 227 WEST MONROE STREET, CHICAGO, IL, 60606-5096, US

(21) Appl. No.: 11/643,567

(22) Filed: Dec. 20, 2006

(30) Foreign Application Priority Data
Dec. 22, 2005 (CN) 200520140151.3

(51) Int. Cl. B28D 1/04

(52) U.S. Cl. 125/13.01

(57) ABSTRACT

The present invention is to provide a tile cutter in simple configuration having a locking device of dual locking functions. The tile cutter comprises a support frame, a cutting device mounted on the support frame, at least one rail disposed on the support frame, a worktable assembly slidably installed in or on a first rail of the at least one rail and a water tray. The first rail has a longitudinal axis. The worktable assembly comprises a first worktable and a second worktable. One of the support frame and the water tray is mounted or placed on the other one of the support frame and the water tray. A locking device is mounted between the first worktable and the second worktable. The locking device comprises a first locking portion and a second locking portion.

### CROSS-REFERENCE TO RELATED APPLICATIONS

This application claims priority to Chinese Application No. 200520140151.3 filed Dec. 22, 2005, the entire disclosure of which is incorporated herein by reference. Priority to this application is claimed under 35 U.S.C. §§ 119, 120 and/or 365.

### FEDERALLY SPONSORED RESEARCH OR DEVELOPMENT

Not Applicable.

### TECHNICAL FIELD

The present invention relates to a tile cutter, in particular to a tile cutter the cutting range of which is increased.

### BACKGROUND OF THE INVENTION

In a conventional tile cutter, usually, a tile is directly put on a worktable fixed relative to the cutter to be cut. However, the maximum cutting range of the tile cutter is generally limited by the dimension of the worktable of the cutter.

To overcome the disadvantage of the conventional tile cutter, in market, a tile cutter which comprises a rail or rails arranged on the base of the tile cutter and a worktable slidably connected to the rail or rails via sliding bearings or rollers is commercially used. But the maximum cutting range of the tile cutter is still limited by the length of the rail. The common method for increasing the cutting range is to increase the length of the rail, which results in deteriorating the portability of the tile cutter. Another method for increasing the cutting range is to increase the size of the portion of the worktable extendable out of the rail. In order to keep the portability of the tile cutter, the worktable may be divided into several portions which can move relative to each other to increase the maximum cutting range. Thus, a locking device is required to be arranged between at least two portions of the worktable to fix the at least two portions together as desired. Additionally, for the tile cutter the worktable of which can slide relative to the rail, in order to fix the worktable on the rail during the transportation to prevent from being damaged or interrupting transportation, a locking device arranged between the worktable and the rail or the base is necessary.

### SUMMARY OF THE INVENTION

The object of the present invention is to provide a tile cutter with simple configuration and a locking device having dual locking functions.

In order to achieve the above mentioned object, a tile cutter according to the present invention comprises a support frame, a cutting device arranged on the support frame, at least one rail disposed on the support frame, a worktable assembly slidably installed in or on a first rail of the at least one rail, and a water tray. The first rail has a longitudinal axis. The worktable assembly comprises a first worktable and a second worktable. One of the support frame and the water tray is arranged or disposed on the other one of the support frame and the water tray. A stopping device is formed or arranged on at least one of the support frame, the worktable assembly and the at least one rail to prevent the worktable assembly from sliding toward a first direction parallel to the longitudinal axis of the first rail. A locking device is mounted between the first worktable and the second worktable. The locking device comprises a first locking portion and a second locking portion.

In order to achieve the above mentioned object, the locking device of the tile cutter provided in the present invention is mounted on one of the first worktable and the second worktable. The second locking portion is fixedly connected to the first locking portion.

In order to achieve the above mentioned object, the locking device of the tile cutter provided in the present invention has three orientation positions, i.e., a first position, a second position and a third position, respectively.

In order to achieve the above mentioned object, the first locking portion of the locking device of the tile cutter provided in the present invention has a contact surface which can be in contact with at least one of the support frame, the water tray and the at least one rail to prevent the worktable assembly from moving toward a second direction opposite to the first direction as the locking device is in the second position and cannot be in contact with the support frame, the water tray and the at least one rail as the locking device is in the first position or the third position.

In order to achieve the above mentioned object, the second locking portion of the locking device of the tile cutter provided in the present invention has a contact surface which can be in contact with the other one of the first worktable and the second worktable to limit the relative movement between them as the locking device is in the first position and the second position and cannot be in contact with the other one of the first worktable and the second worktable as the locking device is in the third position.

The operator can easily fix the first worktable and the second worktable of the worktable assembly together and conveniently fix the relative position between the worktable assembly and the support frame while fixing the relative position between the first worktable and the second worktable, so that it is convenient to transport of the tile cutter without destroying the portability of the tile cutter.

### BRIEF DESCRIPTION OF THE DRAWINGS

According to the practical application of the principle of the present invention, a preferred embodiment is described with reference to the drawings.

FIG. 1 is a perspective view of the tile cutter according to the preferred embodiment of the present invention with the locking device in the first position.

FIG. 2 is a perspective view of the tile cutter in FIG. 1 with the locking device in the second position.

FIG. 3 is a perspective view of the tile cutter in FIG. 1 with the locking device in the third position.

FIGS. 4 and 5 are perspective views of the worktable assembly of the tile cutter in FIG. 1 with the locking device is in the third position.

FIG. 6 is a perspective view of the worktable of the tile cutter in FIG. 1.

FIG. 7 is a perspective view of the worktable assembly of the tile cutter in FIG. 1 with the locking device in the second position.

FIG. 8 is a perspective view of the worktable assembly of the tile cutter in FIG. 1 with the locking device in the third position.

### DETAILED DESCRIPTION

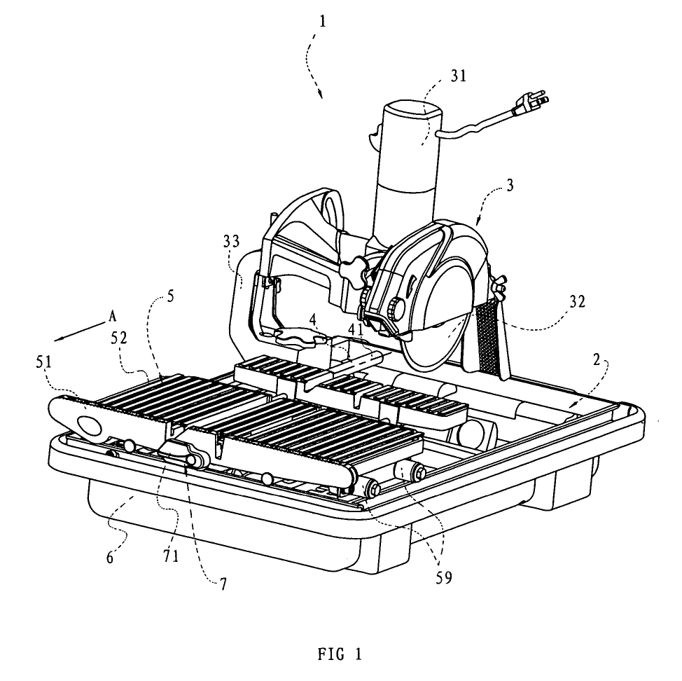

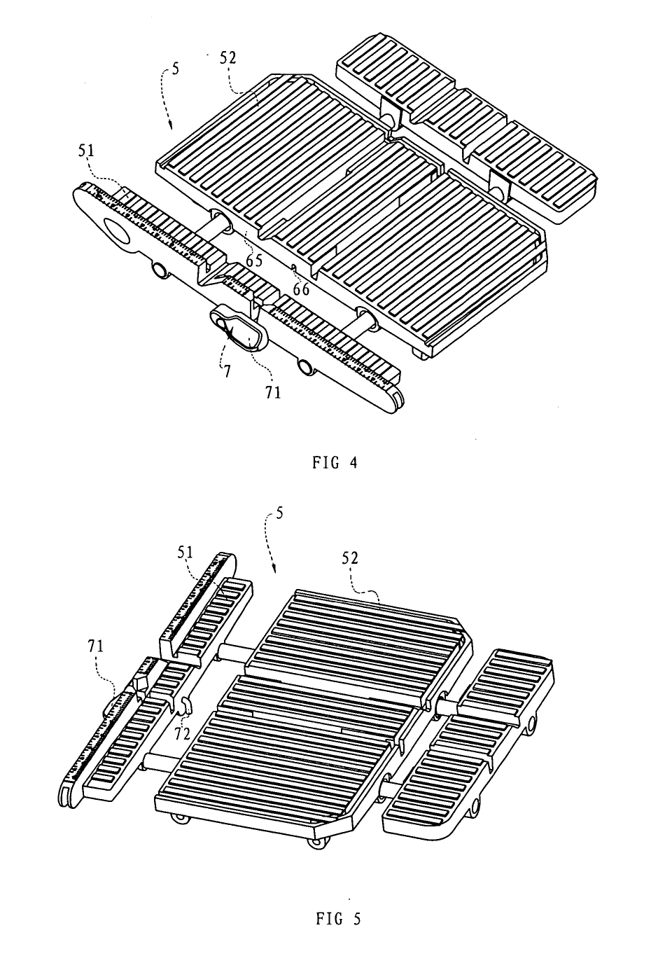

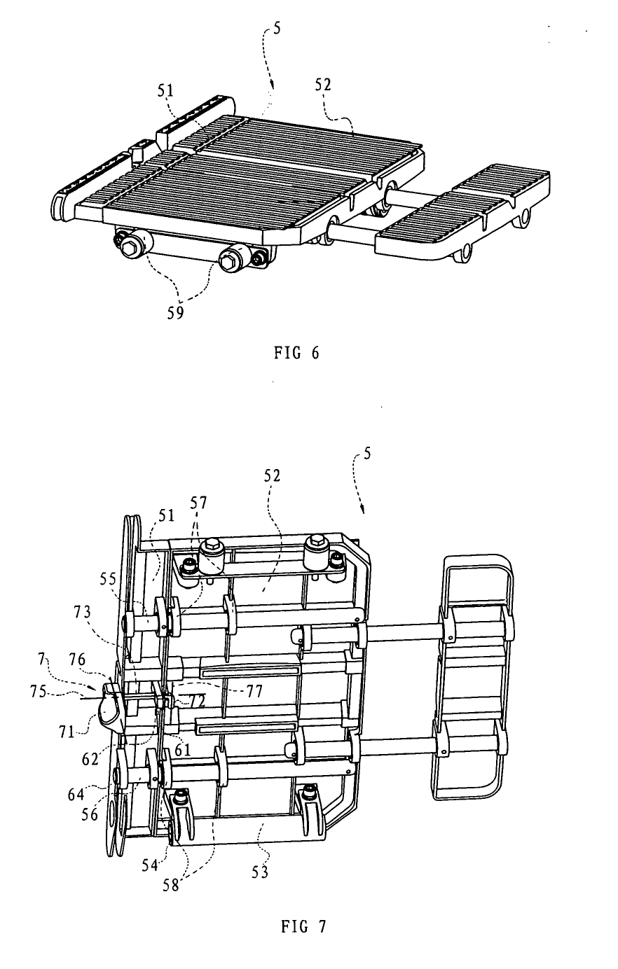

FIGS. 1-8 show a tile cutter of a preferred embodiment according to the present invention. The tile cutter 1 comprises a support frame 2, a cutting device 3, a rail 4, a worktable assembly 5 and a water tray 6.

The stabilizing device 100 further comprises an adjusting device 128 acting between the base plate 102 and the second supporting wall 106, for adjusting the position of the second supporting wall 106 on the base plane 108 so that the second supporting wall 106 is movable and can be fixed on a position between the first supporting wall 104 and the second side edge 112 of the base plate 102, for stabilizing crown moldings with different width. In the preferred embodiment, the support frame 2 is substantially rectangular. The rail 4 has a cylindrical outer surface and two ends of it are disposed on the support frame 2 (as shown in FIGS. 1-3). The rail 4 has a longitudinal axis 41. One ordinary skilled in the art will easily recognize that the support frame and the rail may be configured in other shapes and constructions, one or more rails can be provided and the one or more rails can be made integrally with the support frame as desired. In the present preferred embodiment, the size of the water tray 6 is slightly larger than that of the support frame 2 arranged in the water tray 6. One ordinary skilled in the art will also easily recognize that the water tray can be disposed on the support frame, for example, a tile cutter comprising a water tray arranged on the support frame is disclosed in U.S. Pat. No. 5,676,124.

The cutting device 3 comprises a motor 31 and a cutting element 32 driven by the motor 31. The cutting device is mounted on the support frame 2 through a C-shaped support arm 33.

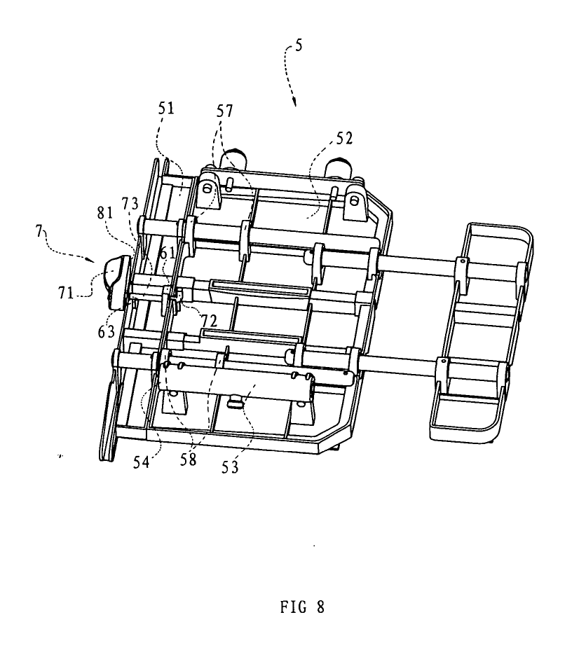

The worktable 5 comprises a first worktable 51 and a second worktable 52. One end of each of two slide bars 55 and 56 in parallel with each other is secured to the bottom of the first worktable 51. The other ends are arranged in the holes of two pairs of protrusions 57, 58 which are located at the bottom of the second worktable 52 and can slide in the holes of the protrusions 57, 58. The top surfaces of the first worktable 51 and the second worktable 52 lies in a common plane. A sleeve 53 with a cylindrical inner surface is secured to the bottom of the second worktable 52 by screws (as shown in FIGS. 7 and 8). The sleeve 53 is set on the rail 4 and can slide to and fro on the rail 4 along the longitudinal axis 41 of the rail 4 so as to slidably attach the worktable assembly to the rail 4. A pair of rollers 59 are arranged on the bottom of the second worktable 52. The rollers 59 are supported by a side of the support frame 2 which is in parallel with the rail 4. Once the rail 4, the support frame 2 and the sleeve 53 have been assembled together with each other, the moving range of the sleeve 53 is limited to be on the portion of the rail 4 within the support frame 2 because the two ends of the rail 4 is fixed to the support frame 2. A side of the support frame 2 contactable with the end 54 of the sleeve 53 serves as a stopping element to stop the movement of the worktable assembly toward a direction denoted by an arrow A as shown in FIG. 1. Obviously, the A direction is in parallel with the longitudinal axis of the rail 41. One ordinary skilled in the art will easily recognize that rollers can be arranged between the second worktable and the rail to achieve the sliding connection, stopping elements of other structures can also be used to limit the maximum movement position of the worktable assembly and the stopping element can be arranged on the water tray, the rail or the worktable assembly as desired.

The tile cutter 1 according to the preferred embodiment further comprises a locking device 7. The locking device 7 comprises a first locking portion 71, a second locking portion 72 and a connecting portion 73 for connecting the first locking portion 71 and the second locking portion 72. A protrusion 61 having a hole 62 is arranged at the bottom of the first worktable 51. A hole 63 corresponding to the hole 62 of the protrusion 61 is provided at an end 64 of the first worktable 51. The connecting portion 73 is an elongate cylinder and inserted through the holes 62 and 63 of the first worktable 51. The connecting portion 73 has a longitudinal axis 75. The first locking portion 71 has a longitudinal axis 76 perpendicular to the longitudinal axis 75 of the connecting portion 73 and is secured to an end of the connection portion 73 adjacent to the end 64 of the first worktable 51. The second locking portion 72 has a longitudinal axis 77 perpendicular to the longitudinal axis 75 of the connecting portion 73 and lies on the other end of the connection portion 73 to be integrated with the connecting portion 73. T he longitudinal axis 76 of the first locking portion 71 is perpendicular to the longitudinal axis 77 of the second locking portion 72. One ordinary skilled in the art will easily recognize that the locking device can be mounted on the second worktable and the first locking portion can also be made integrally with the connecting portion. Of course, the second locking portion and the connection portion can be in the form of two separate elements which are fixedly secured with each other. When the worktable assembly 5 has been mounted to the rail 4, the longitudinal axis 75 of the connecting portion 73 of the locking device 7 is in parallel with the longitudinal axis 41 of the rail 4.

As shown in FIG. 4, a recess 66 is formed on an end 65 of the second worktable 52 which is adjacent to the first worktable 51. A portion of the connecting portion 73 of the locking device 7 of is located in the recess 66. The locking device 7 of the present preferred embodiment has three orientation positions, i.e. a first position, a second position and a third position, respectively.

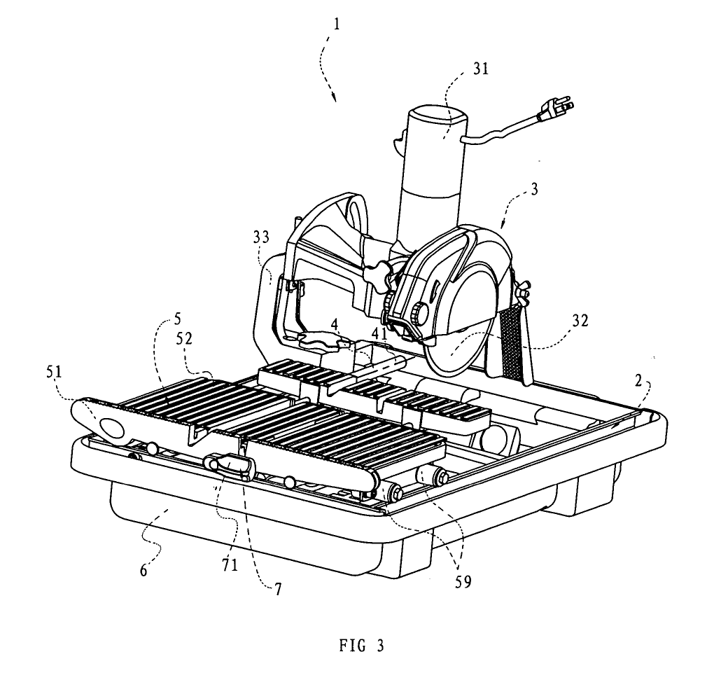

When the locking device 7 is in the third position as shown in FIGS. 3 and 8, the first locking position 71, the longitudinal axis 76 of which is substantially horizontal at this time, can not contact any one of the support frame 2, the water tray 6 and the rail 4, meanwhile the second locking portion 72, the longitudinal axis 77 of which is substantially vertical at this time, can not contact the second worktable 52. At this time, the locking device is in a free position, that is, the locking device can neither lock the relative position between the first worktable and the second worktable nor lock the relative position between the worktable assembly and the support frame.

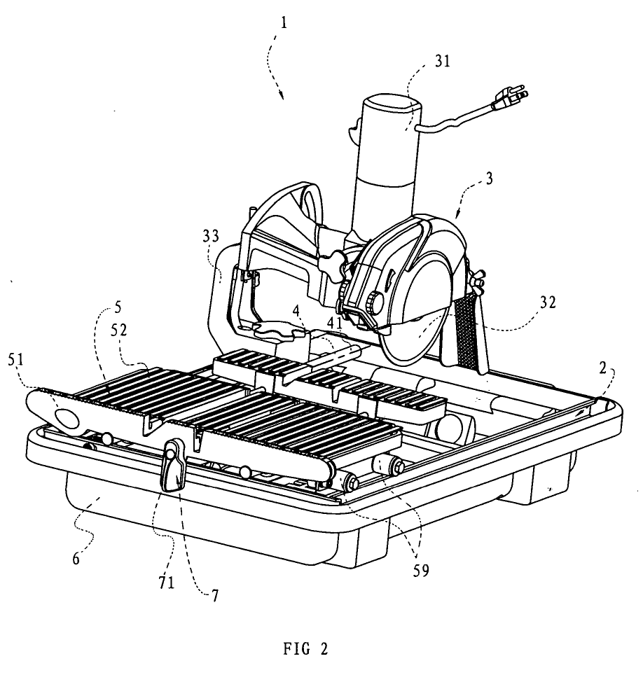

When the locking device 7 is in the second position as shown in FIGS. 2 and 7, a surface 81 of the first locking portion 71 may contact an outer edge of the water tray 6 to prevent the first worktable 51 from moving toward a direction opposite to the direction A. The longitudinal axis 76 of the first locking portion 71 is substantially vertical at this time. At the same time, a part of a surface of the second locking portion 72 can contact the inner surface of the end 65 of the second worktable 52 to lock the relative position between the first worktable 51 and the second worktable 52. The longitudinal axis 77 of the second locking portion 72 is substantially horizontal at this time. In this manner, the locking device can lock both the relative position between the first worktable and the second worktable and the relative position between the worktable assembly and the support frame.

When the locking device is in the first position as shown in FIG. 1, the first locking device 71, the longitudinal axis 76 of which is substantially horizontal at this time, can not contact any one of the support frame 2, the water tray 6 and the rail 4. And meanwhile, the second locking portion 72, the longitudinal axis 77 of which is substantially vertical at this time, directs upward. A part of the surface of the second locking portion 72 can contact the inner surface of the end 65 of the second worktable 52 so as to lock the relative position between the first worktable 51 and the second worktable 52. In this manner, the locking device can lock the relative position between the first worktable and the second worktable but cannot lock the relative position between the worktable assembly and the support frame.

The preferred embodiment described above is only used to set forth the conception and principle of the present invention in detail and not intended to limit the range of the present invention. One ordinary skilled in the art will recognize that there are also various modifications or alternatives without departing the conception and principle of the present invention. The scope of the present invention is defined by the appended claims.

What is claimed is:

1. A tile cutter, comprising: a support frame, a cutting device mounted on said support frame, at least one rail disposed on said support frame, a worktable assembly slidably installed in or on a first rail of said at least one rail and a water tray, said first rail having a longitudinal axis, said worktable assembly comprises a first worktable and a second worktable, one of said support frame and said water tray is mounted or placed on the other one of said support frame and said water tray, a stopping device is formed or arranged on at least one of said support frame, said worktable assembly and said at least one rail to prevent said worktable assembly from sliding toward a first direction parallel to said longitudinal axis of said first rail, wherein a locking device is mounted between said first worktable and said second worktable and comprises a first locking portion and a second locking portion.

2. A tile cutter according to claim 1, wherein said locking device is mounted on one of said first worktable and said second worktable, and said second locking portion is fixedly connected to said first locking portion.

3. A tile cutter according to claim 2, wherein said locking device has three orientation positions, i.e. a first position, a second position and a third position, respectively.

4. A tile cutter according to claim 3, wherein said first locking portion has a contact surface, which can be in contact with one of said support frame, said water tray and said at least one rail to prevent said worktable assembly from moving toward a second direction opposite to said first direction as said locking device is in said second position and can not be in contact with said support frame, said water tray and said at least one rail as said locking device is in said first position or said third position.

5. A tile cutter according to claim 3, wherein said second locking portion has a contact surface, which can be in contact with the other one of said first worktable and said second worktable to limit the relative movement between said first worktable and said second worktable as said locking device is in said first position and said second position and can not contact with said other one of said first worktable and said second worktable as said locking device is in said third position.

6. A tile cutter as in any of the preceding claims, wherein said locking device further comprises a connecting portion lying between said first locking portion and said second locking portion for connecting said first locking portion and said second locking portion.

7. A tile cutter according to claim 6, wherein said connecting portion has a longitudinal axis which is in parallel with said longitudinal axis of said first rail.

8. A tile cutter according to claim 7, wherein each of said first locking portion and said second locking portion has a longitudinal axis perpendicular to the longitudinal axis of said connecting portion.

9. A tile cutter according to claim 8, wherein said longitudinal axis of said first locking portion is perpendicular to said longitudinal axis of said second locking portion.

10. A tile cutter, comprising: a support frame, a cutting device mounted on said support frame, at least one rail disposed on said support frame, a worktable assembly slidably installed in or on a first rail of said at least one rail and a water tray, said first rail having a longitudinal axis, said worktable assembly comprises a first worktable and a second worktable, one of said support frame and said water tray is mounted or placed on the other one of said support frame and said water tray, wherein a locking device is mounted on one of said first worktable and said second worktable and comprises a first locking portion, a second locking portion and a connection portion.

11. A tile cutter according to claim 10, wherein said locking device has three orientation positions, orient, respectively.

12. A tile cutter according to claim 11, wherein said first locking portion has a contact surface, which can be in contact with one of said support frame, said water tray and said at least one rail to prevent said worktable assembly from moving toward a direction which is parallel to said longitudinal axis of said first rail and is toward said cutting device as said locking device is in said second position and can not be in contact with said support frame, said water tray and said at least one rail as said locking device is in said first position or said third position.

13. A tile cutter according to claim 11, wherein said second locking portion has a contact surface, which can be in contact with the other one of said first worktable and said second worktable to limit the relative movement between said first worktable and said second worktable as said locking device is in said first position and said second position and can not contact with said other one of said first worktable and said second worktable as said locking device is in said third position.

14. A tile cutter as in claim 10, 11, 12 or 13, according to any one of the claims 10 to 13, wherein said connecting portion has a longitudinal axis which is in parallel with said longitudinal axis of said first rail.

15. A tile cutter according to claim 14, wherein each of said first locking portion and said second locking portion has a longitudinal axis perpendicular to the longitudinal axis of said connecting portion.

16. A tile cutter according to claim 15, wherein said longitudinal axis of said first locking portion is perpendicular to said longitudinal axis of said second locking portion.

17. A tile cutter, comprising: a support frame, a cutting device mounted on said support frame, at least one rail disposed on said support frame, a worktable assembly slidably installed in or on a first rail of said at least one rail and a water tray, said first rail having a longitudinal axis, said worktable assembly comprises a first worktable and a second worktable, one of said support frame and said water tray is mounted or placed on the other one of said support frame and said water tray, wherein a locking device is mounted on one of said first worktable and said second worktable and comprises a first locking portion, a second locking portion and a connection portion which fixedly connects said first locking portion to said second locking portion and has a longitudinal axis which is parallel to said longitudinal axis of said first rail, wherein each of said first locking portion and said second locking portion has a longitudinal axis perpendicular to the longitudinal axis of said connecting portion, and wherein said longitudinal axis of said first locking portion is perpendicular to said longitudinal axis of said second locking portion, said locking device has a first orientation position, a second orientation position and a third orientation position, respectively.

18. A tile cutter according to claim 17 further comprising a stopping device is formed or arranged on at least one of said support frame, said worktable assembly and said at least one rail to prevent said worktable assembly from sliding toward a first direction parallel to said longitudinal axis of said first rail.

19. A tile cutter according to claim 18, wherein said first locking portion has a contact surface, which can be in contact with one of said support frame, said water tray and said at least one rail to prevent said worktable assembly from moving toward a second direction opposite to said first direction as said locking device is in said second position and can not be in contact with said support frame, said water tray and said at least one rail as said locking device is in said first position or said third position.

20. A tile cutter according to claim 18, wherein said second locking portion has a contact surface, which can be in contact with the other one of said first worktable and said second worktable to limit the relative movement between said first worktable and said second worktable as said locking device is in said first position and said second position and can not contact with said other one of said first worktable and said second worktable as said locking device is in said third position.
